(19) United States
(12) Patent Application Publication
(10) Pub. No.: US 2008/0155493 A1
(43) Pub. Date: Jun. 26, 2008

(54) Method for ensuring unique identification of program elements across multiple executions

(76) Inventor: Dror Zernik, Haifa (IL)

Correspondence Address: Kevin D. McCarthy;Roach Brown McCarthy & Gruber, P.C., 1620 Liberty Building, 420 Main Street, Buffalo, NY, 14202, US

(21) Appl. No.: 11/644,436

(22) Filed: Dec. 22, 2006

(51) Int. Cl. G06F 9/00; G06F 9/44

(52) U.S. Cl. 717/100

(57) ABSTRACT

Method for allowing invariant identification of selected objects displayed during the execution of an object oriented application, by another application. According to the proposed method, a tag generator is determined, for uniquely tagging each of the selected objects and then the tag generator generates a plurality of different and unique tags. Access of object generating functions in the source code of the application, to a collection of different and unique tags is established. A unique tag from that collection is automatically attached to the object, such that the attached tag is added to the attributes of the selected object, whenever a selected object that should be invariantly identified is generated during the execution of the application. This way, the another application is allowed to identify and access one or more objects through an interface of the application, according to their corresponding unique tags, which are invariant across all application invocations and updates.

### FIELD OF THE INVENTION

The present invention relates to the field of software integration. More particularly, the invention relates to a method for building automatic interfaces to exiting programs that can be changed and updated, while eliminating the need for re-programming whenever such changes in the programs are made.

### BACKGROUND OF THE INVENTION

Several techniques have been developed, in order to monitor existing programs and interact with them through an appropriate interface, in order to identify each filed in the displayed screen. Some of these techniques are extremely invasive and require re-programming. Others require only building wrappers, and still other techniques are almost non-intrusive and rely on object models that are exposed by the underlying system. Intensive re-programming is not desired due to several reasons. It requires heavy programming resources for altering an existing program. This problem becomes more severe, particularly when the existing program is an old one. More over, it requires a complete development life-cycle, even if only a wrapper is constructed, such as proposed by IBM's WebSphere Software, or by Microsoft's BizTalk (which is a business process management (BPM) server that enables companies to automate and optimize business processes). In some cases, heavy usage of the Application Program Interface (API) is required, which sometimes exposes features which were not fully supported.

An example of using underlying object model engines is disclosed for example in U.S. Pat. No. 5,889,518, which describes an apparatus for acquiring, processing and routing data contained in a graphical user interface window. The data contained in a window selected by the user is captured by an acquisition unit and stored in a data buffer. The data, whether string data or bitmapped graphics data, is stored in the data buffer in standard graphical user interface text and/or bitmapped format. A user may designate a portion of the acquired data to be processed by a processor for adding functionality to an application associated with the graphical user interface window selected by the user.

Other techniques use “Screen Scarping”, where text or other data is extracted from the display of the program, while ignoring the binary information that the display carries, by using the visual properties of the screen, effectively imitating the way a human would view the display.

All the methods described above have not yet provided satisfactory solutions to the problem of providing automatic interfaces to exiting programs that can be changed and updated.

It is an object of the present invention to provide automatic interfaces to exiting programs that, although said programs be changed and updated, the present invention eliminates the need for re-programming whenever such changes are made.

It is another object of the present invention to provide automatic interfaces to exiting programs while keeping stability regarding changes within the observed, monitored program.

It is a further object of the present invention to provide automatic interfaces to exiting programs that can identify desired displayed objects in a varying dynamic display environment.

Other objects and advantages of the invention will become apparent as the description proceeds.

### SUMMARY OF THE INVENTION

The present invention is directed to a method for allowing invariant identification of selected objects displayed during the execution of an object oriented application, by another application. According to the proposed method, a tag generator is determined, for uniquely tagging each of the selected objects and then the tag generator generates a plurality of different and unique tags. Access of object generating functions in the source code of the application, to plurality of different and unique tags is established. A unique tag from that plurality is automatically attached to the object, such that the attached tag is added to the attributes of the selected object, whenever a selected object that should be invariantly identified is generated during the execution of the application. This way, the another application is allowed to identify and access one or more objects through an interface of the application, according to their corresponding unique tags, which are invariant across all application invocations and updates.

The selected objects may be objects that can be created in a variety of ways by the underlying execution system, which can be an operating system, or a VM in Net or Java.

Tags may be determined according to the hierarchy of their corresponding objects with respect to other objects. Whenever the application is a browser interpreting an HTML page, interaction with the operating system level is avoided, while referring only to the browser's interface functions. In this case, tags may be generated in XML documents.

Whenever the application is executed in an environment without a direct non programmatic interface (such as a Visual Basic), each selected object is tagged by generating a unique tagging function that can be called by the application. Then a first event is defined whenever such an object is generated and a unique tag is selected for the first event by calling the tagging function. A second event is defined whenever the unique tag is associated with the object. Then the application is allowed to proceed to the next executable step.

The other application may be used for monitoring the running application or for evaluating the application and the user's state of interaction. The other application may actively interact with the objects, in a similar way to a user interaction(s).

### BRIEF DESCRIPTION OF THE DRAWINGS

In the drawings:

FIG. 1 (prior art) illustrates a three tier software architecture;

FIG. 2 (prior art) illustrates A Graphical User Interface (GUI) of an HTML application;

FIG. 3 (prior art) schematically illustrates an architecture for interfacing a running program for monitoring purpose through its GUI; and

FIG. 4 schematically illustrates architecture for interfacing a running program for monitoring purpose, according to a preferred embodiment of the invention.

### DETAILED DESCRIPTION OF PREFERRED EMBODIMENTS

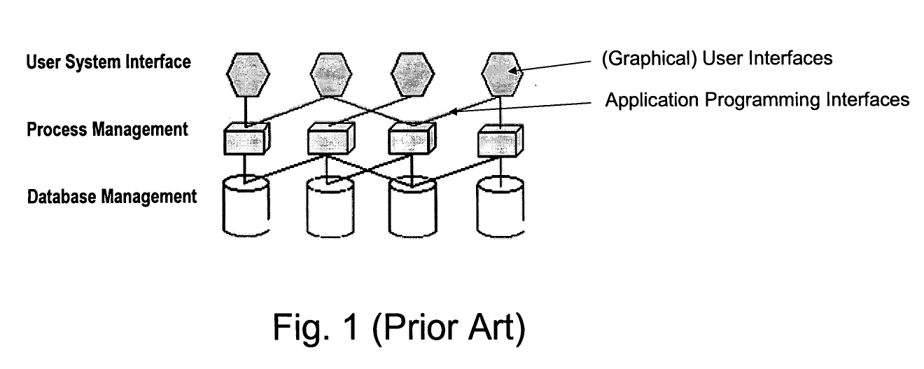

FIG. 1 (prior art) illustrates a three tier software architecture. The middle tier server is added between the user interface (client) and the data management (server) components and provides process management where business logic and rules are executed and can accommodate hundreds of users by providing functions such as queuing, application execution, and database staging. This architecture is used when an effective distributed client/server design with increased performance is needed.

The distributed client/server architecture includes a user system interface (top tier) where user services (such as session, text input, dialog, and display management) reside.

The third tier provides database management functionality and is dedicated to data and file services, such as data locking, consistency, and replication. The connectivity between tiers can be dynamically changed depending upon the user's request for data and services.

The middle tier (the application server) provides process management services (process development, monitoring) that are shared by multiple applications. The application server improves performance by centralizing process logic that makes administration and change management easier by localizing system functionality. By doing so, changes must only be written once and placed on the middle tier server to be available throughout the systems, rather than writing a change to a function (service) into every application.

A similar approach is used when a wrapper or Service Oriented Architecture (SOA) is used for integration. By providing a middle tier, such as NetWeaver (by S.A.P Aktiengesellschaft, Walldorf, Germany), a communication layer between the various applications is introduced, which allows for interfacing any such application from any other application, as long as the both sides conform to the underlying communication protocols.

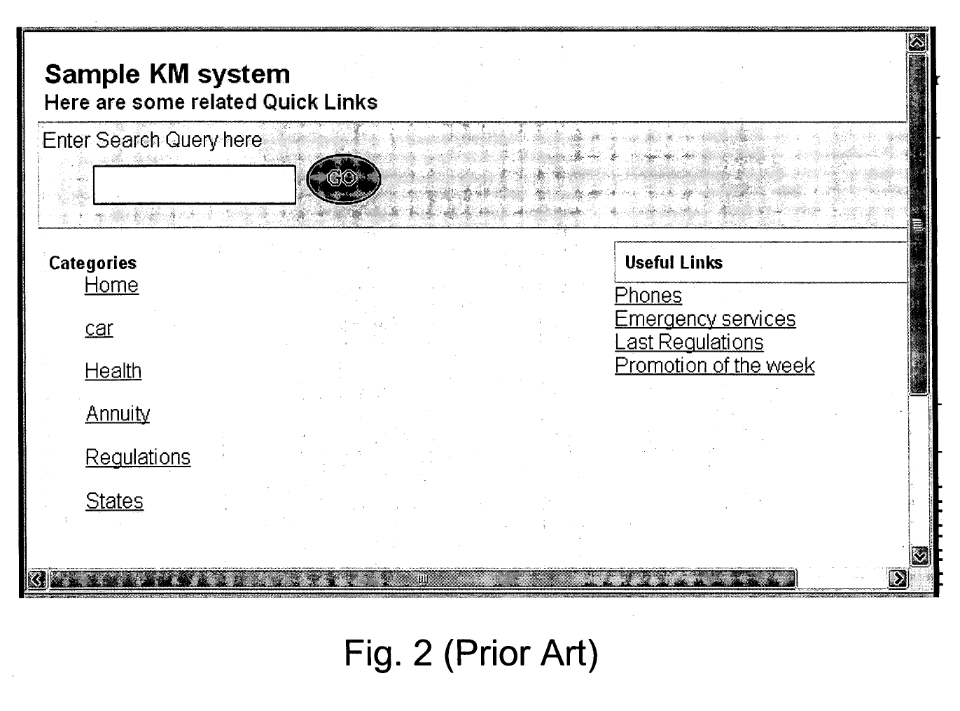

FIG. 2 (prior art) illustrates A Graphical User Interface (GUI) of an HTML application. This GUI comprises a screen of an HTML page, with several links and/or fields, each of which is an object that needs to be identified by a programmatic interface. As long as there is no change in the page structure, objects within the page can be identified, e.g., by their location of display. However, such an HTML page can be changed or updated, e.g. by adding new objects and changing the location of display of old objects. In this case, the programmatic interface will not necessarily be able to identify all the old objects. Note that for HTML pages, this is a common issue, as pages are typically generated by applications, either on the server side (ASP) or on the page itself (JavaScript).

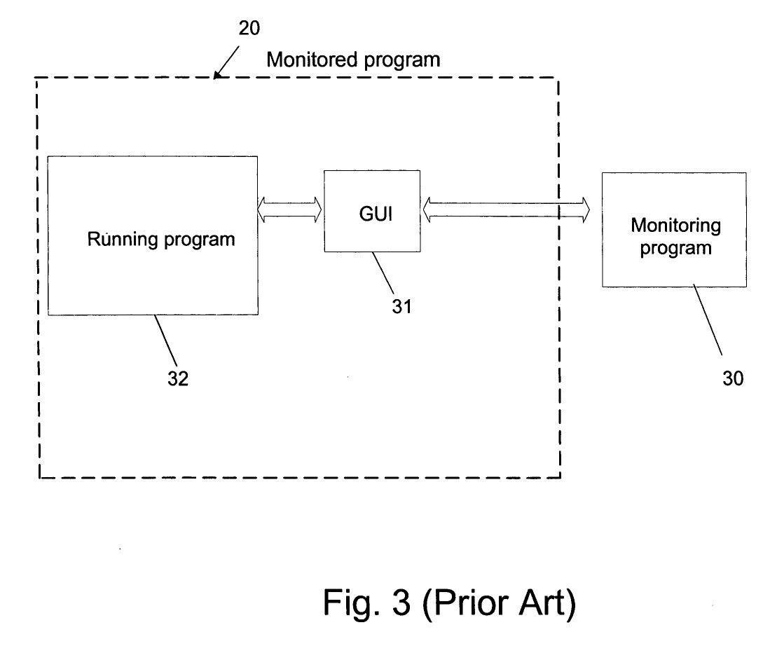

FIG. 3 (prior art) schematically illustrates an architecture for interfacing a running program for monitoring purpose through its GUI. The monitoring application 30 exploits the GUI 31 of the running program 32 to track events during the execution of the program, by identifying objects that are displayed. The combination of GUI 31 and the running program 32 constitute the monitored program 20. Again, this object identification technique is effective, as long as there are no substantial changes in either the objects' construction mechanism, object hierarchy, or the location of graphical elements of the display.

In contradiction to the prior art techniques described above, the present invention proposes a novel approach, which provides stability regarding changes within the observed, monitored program. The invention relies on the object models that the application exposes, but provides also an automatic mechanism for uniquely tagging objects, in a manner which is independent of programming interfaces, and at the same time, remains stable across multiple invocations of the program, or in the face of updates and changes to the program.

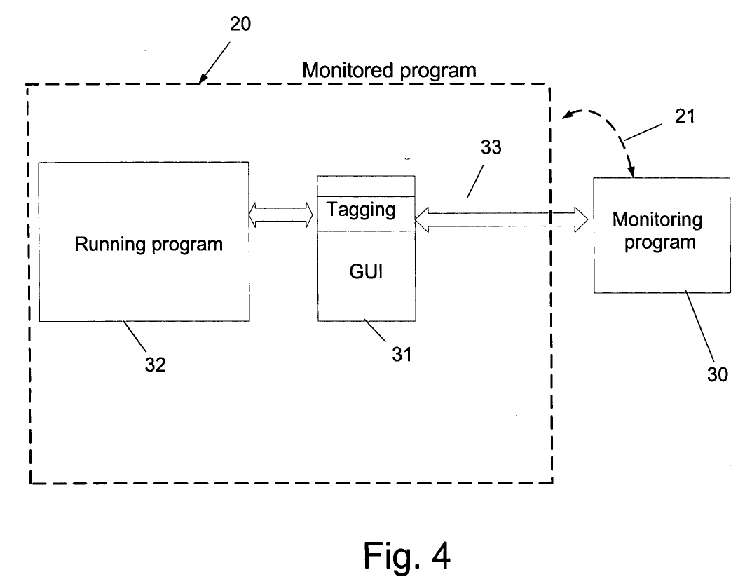

FIG. 4 schematically illustrates architecture for interfacing a running program for monitoring purpose, according to a preferred embodiment of the invention. The monitoring program 30 exploits the tagging attribute 33 embedded into objects that are displayed and can be manipulated by GUI 31 of the running program 32 to track events during the program and GUI execution, by uniquely identifying objects that are displayed. This object identification technique is effective, even when there are version updates, a change in the objects' display property, or even changes in the object hierarchy.

The original application is the monitored program 20, and to the external application is the monitoring program 30. The functionality of the monitoring program is not restricted to monitoring only, but rather it can also activate features within the monitored program. The monitor is therefore an external controller of the application, or simply another program which interacts with the application.

The present invention provides means for semi-automatically generating unique identifiers for elements within the program, which will allow clear and unique identification across multiple execution of the program, and remain stable even when the program is modified. The unique tagging method proposed by the present invention can be applied to Web pages, as well as to programming environments such as Visual Basic, and alike, where objects can be accessed using a GUI or an API only. The present invention provides unique naming (tagging) for each object, and a quick manner for identifying and locating the desired object from the external monitoring program 30. This solution provides several advantages over prior art solutions:

### 1. Uniqueness:

Each tag is unique per application; hence, a tag appears at most once within an application screen;
A tag is always associated with the same, single element (object)
If the element appears, so is its corresponding tag.
Not all the objects must be tagged

Since not all the objects must be tagged, there are some guideline rules for tagging, which are often technology specific:
Subsuming objects' completeness—composite objects, such as tables, grids, frames, and documents, in which sub elements are needed, should be tagged as well, or alternatively, a global uniqueness for the composite object must be ensured.
Meaningful naming—the tag can be meaningful, by providing an association to the data element it refers to. This may often generate a global uniqueness, which eliminates the need for subsuming the object tagging. This does not mean, necessarily that manual naming is required, but rather that some of the unique object properties are gathered into the tag.

### TAGGING SOLUTION EXAMPLES

### 1. Example 1

### HTML Tagging—Tagging Format

Web browsers such as Internet Explorer, Netscape's Mozilla (FireFox) and others expose multiple object hierarchies such as Document Object Model (DOM) and HTML2.

These are runtime representations of the HTML documents, which form a standard document structure and a way of hierarchically arranging content. More specifically, an HTML element is an element that matches at least one of the HTML Document Type Definitions (DTDs). An HTML element has properties of attributes and content. Elements may represent headings, paragraphs, tables, hypertext links, lists, embedded media, and so on. While this is the static representation of the page, during the browser-server interaction, Web pages can also contain programs, such as Personal Home Page (PHP, which is a scripting language and creates a “dynamic HTML page”, since content will vary based on the results of interpreting the script) on the server side, or JavaScripts—on the browser side, which eventually produces HTML documents. Accordingly, each HTML element can be created with a variety of properties and contents, as a result of these programs. Similarly, dynamic HTML pages can be created as a result of the use of extended Markup Language (XML).

In addition, objects may be created by the operating system that executes an application of by a Virtual Machine (an operating system that can host other operating systems, so that each of the operating systems seems to have its own complete system of software and hardware resources), Java applications and applications the run on Microsoft's .NET platform.

Since HTML pages can rapidly change from one invocation of the browser to another invocation, screen scraping technology will not be sufficient, as the display properties rapidly change. Further, even relying on a fixed object hierarchy is insufficient for the same reason. According to the solution proposed by the present invention, this task is performed by the monitoring program 30, while implementing the tagging mechanism:

Option 1—Unique (global) numbering: According to this option, the tag contains: <Naming-header><Global Number>

The tag is added as an attribute to the HTML page, which may be any predefined string. The global number must be set in agreement between the monitoring and monitored program, and hence, it is fixed. For example, this can be done based on the order of appearance in any of the GUI documentation. Note that setting a counter and dynamically allocating a tag may be sufficient for a single execution, but does not guarantee the stability and the identification across multiple invocations of the page, and clearly is not stable under changes in the page over time.

Option 2—Control name: In this alternative each tag for each control contains information indicating for:

<Naming-header><Control Name>

The Control Name is derived from the class name, or from the semantics of the object (for example, the XML hierarchy, or generating script), but must conform with the uniqueness requirements within the level it is created. Hence, if two objects of the same type are being constructed within a list, their order must be preserved, or alternatively, they must be uniquely identified within the list they reside in. In this case, a complete parsing (analyzing an input sequence read for example, from a file or a keyboard,) in order to determine its grammatical structure) may be required—as a similar tag may appear in various parts of the object hierarchy. Therefore, the path to each such object is unique.

Option 3—Control name and relative number: In this alternative each tag contains at least:

<Naming-header><Control Name><Relative Number> where like in Option 2, the Control Name is derived from the class name. However, if it cannot be always unique per subsuming class, the enumeration within a page, or at least within the subsuming class must be preserved. The enumeration is the order agreed with the monitoring application (rather than the order of creation).

### Example 2

### Tagging Visual Basic Programs—Tagging Mechanism

Unlike in HTML, where textual representation is the dominant form of representing the program, and the browser interprets this program into a visual representation, some common programming environments do not easily expose a textual representation of the program. Moreover, even if such a representation does exist, and is exposed, directly editing this code is highly uncommon, for example, in order to add an attribute. Instead, programming interfaces allow the user to add, delete or modify object attribute values. In the context of predefined tagging, this introduces a challenge, as:
The monitoring program typically awaits for the creation event of each object, in order to interact with it and verify its attributes
Properties of an object can be set only after it has been created.

Accordingly, while in HTML-based environments and their kin pre-tagging can be easily implemented, in order to tag an object such as common in Visual Basic and similar programs, there is a need to add an additional component in the system, hence a special event, which complements the object creation, and can be recorded by the monitoring program 30. We refer to this as “lazy tagging”. The tagging format can conform to any of the formats mentioned in Example 1, the tagging injection needs to be done programmatically, and the invocation of the tagging function should occur only after the creation of the need-to-be-tagged object. An event is generated upon completion of tagging task by the tagging function, so as to notify the monitoring program 30 that the tagged object is now ready for monitoring.

1. Method for allowing invariant identification of selected objects generated during the execution of an object oriented application, by another application, comprising:
a) determining a tag generator, for uniquely tagging each of said selected objects;
b) generating a plurality of different and unique tags by said tag generator;
c) establishing access of object generating functions in the source code of said application to plurality of different and unique tags;
d) whenever a selected object that should be invariantly identified is generated during the execution of said application, automatically attaching a unique tag from said plurality, to said object, such that the attached tag is added to the attributes of said selected object; and
e) allowing said another application to identify and access one or more objects through an interface of said application, according to their corresponding unique tags, which are invariant across all application invocations and updates.

2. Method according to claim 1, wherein the selected objects are objects that can be created in a variety of ways by the underlying execution system.

3. Method according to claim 2, wherein the underlying execution system is selected from:
a) an operating system;
b) a VM in Net or Java;
c) an execution application.

4. Method according to claim 3, wherein the execution application is a Web browser.

5. Method according to claim 1, wherein different and unique tags are determined according to the hierarchy of their corresponding objects with respect to other objects.

6. Method according to claim 1, wherein whenever the application is a browser interpreting an HTML page, interaction with the operating system level is avoided, while referring only to the browser's interface functions.

7. Method according to claim 1, wherein the application is a browser and the tags are generated in XML documents.

8. Method according to claim 1, wherein whenever the application is executed in an environment without a declarative method to pre-define a tag per object, tagging each selected object by:
a) generating a unique tagging function that can be called by said application;
b) identifying a first event whenever an object is generated;
c) selecting a unique tag for said first event by calling said tagging function;
d) defining a second event whenever said unique tag is associated with said object; and
e) allowing said application to proceed to the next executable step.

9. Method according to claim 6, wherein the environment is a Visual Basic environment.

10. Method according to claim 1, wherein the other application is used for monitoring the application.

11. Method according to claim 8, wherein the monitoring application is used for evaluating the application and the user's state of interaction.

12. Method according to claim 1, wherein the other application is actively interacting with said objects, in a similar way to a user interaction(s).
